(19) United States
(12) Patent Application Publication
(10) Pub. No.: US 2006/0193958 A1
(43) Pub. Date: Aug. 31, 2006

(54) Brown sugar substitute

(76) Inventor: William J. Chapello, Atlantic Highlands, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/171,103

(22) Filed: Jun. 30, 2005

Related U.S. Application Data
(60) Provisional application No. 60/657,209, filed on Feb. 28, 2005.

(51) Int. Cl. A23L 1/236

(52) U.S. Cl. 426/548

(57) ABSTRACT

A brown sugar substitute containing a high intensity sweetener, molasses, a food grade crystalline sugar or sugar alcohol, and at least one anti-caking agent is provided. Compositions containing the brown sugar substitutes and packaged forms of the brown sugar substitutes are also provided. Further provided are methods of making the brown sugar substitutes.

This application claims benefit under 35 U.S.C. § 119(e) of U.S. Provisional Application No. 60/657,209, filed Feb. 28, 2005.

### FIELD OF THE INVENTION

The present invention relates to brown sugar substitute compositions that resist caking even at very low relative humidity. More particularly, the present invention relates to brown sugar substitute compositions containing a food-grade crystalline sugar or sugar alcohol, molasses, a high intensity sweetener, and at least one anti-caking agent. The anti-caking agents include glycerin, propylene glycol, and mixtures thereof. The present invention also relates to methods of producing such brown sugar substitutes.

The brown sugar substitute compositions of the present invention may be used in all applications in which brown sugar can be used.

### BACKGROUND OF THE INVENTION

People often customize the taste of food and beverages by adding sweeteners thereto. For example, sweeteners are added to beverages, such as, coffee and tea; on cereals; on fruit; as toppings on baked goods, and in many other ways. Sweetening a food or beverage alters its flavor and usually increases its appeal. This behavior is found in all cultures, but is especially prevalent in western cultures.

The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in wide spread use, is produced from, e.g., sugar cane and sugar beet roots.

Sugar alcohols are another form of sweetener. Sugar alcohols are chemically alcohols, but are derived from sugar molecules. Sugar alcohols vary in sweetness from half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to, e.g., nutritive sweeteners. Some high intensity sweeteners, such as, aspartame, are nutritive, but are so intense that they still provide negligible calories because very small amounts are required. Other high intensity sweeteners, such as, for example sucralose, are not absorbed when ingested and are therefore non-nutritive sweeteners.

Other sweetener compositions are also available as blends of two or more sweeteners. Brown sugar is an example of this type of sweetener. Brown sugar usually contains, in addition to pure sucrose as the principle constituent, a coating of molasses, which imparts the distinctive flavor and color to this type of sweetener. The molasses, which is composed of sucrose, invert sugar, ash, water, and other crystallizable and non-crystallizable compounds, surrounds the pure sucrose crystals in the form of a thin film. Brown sugar is used, for example, in the home and in the food industry to develop a rich molasses-type flavor in, e.g., cookies, candies, and similar products. True raw sugars are similar to brown sugar, but may have the molasses-like components distributed in inclusions in the sucrose crystalline matrix, as well as on the surface.

Many sugar refiners produce brown sugar by boiling sugar cane syrup until brown sugar crystals are formed. A centrifuge spins the crystals dry. Some of the syrup remains on the sucrose crystals giving the sugar its brown color and molasses flavor. Other manufacturers produce brown sugar by blending a sugar cane molasses syrup with white sugar crystals.

The traditional sucrose-molasses brown sugar products have a high caloric content-typically about 4 kcal per gram. In a recipe calling for 300 grams of traditional sucrose-molasses brown sugar, 1,200 kcals will be added. Accordingly, efforts have been made to reduce the caloric burden of traditional sucrose-molasses brown sugar.

One such effort is found in the Brown SWEET 'N LOW® brand. This product contains nutritive dextrose, natural molasses flavor, 3.6% Saccharin (18 milligrams per teaspoon of sugar sweetening equivalence), caramel color, cream of tartar, and calcium silicate. This product has about 80 kcals per 1 cup brown sugar equivalent (8 teaspoons brown SWEET 'N LOW per 1 cup brown sugar equivalent). However, this product uses molasses flavor, rather than molasses, due to the effect of the high water content of the molasses on the structure of the low calorie formulation. The molasses flavor allows for a dry form of the product, which is necessary to provide for consistent measurement and ease of packaging of the product. However, the use of molasses flavor results in a product with a less than desirable flavor.

Brown sugar and/or substitutes containing nutritive sweetener crystals coated with a molasses based composition tend to cake as moisture is lost from the molasses. With the proper amount of moisture, the molasses remains in a syrup-like state and the brown sugar substitute will retain a wet feel that is favored by consumers. However, as moisture is lost, the sugar in the molasses begins to crystallize. As the molasses crystallizes, it tends to form bridges between the brown sugar particles. This bridging leads to large, solid agglomerations of brown sugar and/or substitute particles. This agglomeration produces large clumps of caked brown sugar substitute, which can be so hard that it may be difficult to measure or use the product for, e.g., cooking or baking.

The degree and speed at which the brown sugar substitute will cake is directly related to the relative humidity at which the brown sugar substitute is stored. At high relative humidity, e.g. 65%, minimal caking may occur. However, at a more conventional relative humidity, e.g. 35%, the brown sugar substitute will likely form the hard clumps discussed above.

To avoid such undesirable caking, brown sugar substitutes have been made that include fat-coated sucrose crystals that are further coated with molasses. The fat used is a hydrogenated soybean oil solvent or partially hydrogenated soybean oil. Such brown sugar substitutes do not “lump” when stored or incorporated into dry mixes (e.g., cookie or cake. mixes) that include humectant materials. These compositions, however, have an increased caloric burden caused by the use of the fat.

Other attempts have been made to prevent caking in brown sugar substitute compositions, e.g., by drying the brown sugar to form a free-flowing composition. For example, another kind of brown sugar substitute is made by drying granular brown sugar and coating the dried brown sugar with a “non-hygroscopic material”. In this way, the non-hygroscopic material adheres to the surface of the molasses. In this manner, the adhesion of one molasses-coated particle to a nearby molasses-coated particle is retarded by the non-hygroscopic layer, which does not exhibit adhesive properties.

In another brown sugar substitute, a free-flowing brown sugar is prepared by first mixing a “dry additive material” to the brown sugar. Thereafter, a polyol is added while continuing to mix. In this manner, the brown sugar is separated into discrete particles before addition of the polyol to produce better coating of the particles with the polyol. Reportedly, such a product readily passes through a screen that would be plugged by a soft sugar, such as untreated brown sugar.

The free-flowing brown sugar substitutes described above, however, exhibit physical characteristics akin to granulated sugar. Thus, these free-flowing brown sugar substitutes bear little resemblance to the brown sugar commonly recognized by consumers, and thus are less accepted by the consumer.

In view of the foregoing, it would be desirable to provide a brown sugar substitute with a reduced caloric burden while maintaining the full taste, functionality, and physical properties of traditional sucrose-molasses brown sugar that are well known to, and accepted by, consumers. It would also be advantageous to provide such a brown sugar substitute that additionally resists caking, even at low relative humidity, while retaining the wet feel recognized by consumers. These and other objects of the present invention are described in greater detail below.

### SUMMARY OF THE INVENTION

The present invention provides a brown sugar substitute composition containing from about 0.01 to about 3% by weight of a high intensity sweetener, from about 1 to about 16% by weight of molasses, from about 70 to about 99% by weight of a food grade crystalline sugar or sugar alcohol, and from about 1.25 to about 5% by weight of at least one anti-caking agent.

The present invention also provides a brown sugar substitute composition containing from about 80 to about 95% by weight of a food grade crystalline sugar or sugar alcohol, from about 4 to about 16% by weight of molasses, from about 1.25 to about 3% by weight of at least one anti-caking agent, and from about 0.01 to about 3% by weight of a high intensity sweetener, wherein less than about 3.5 kcals per gram of sucrose equivalent sweetness are delivered.

The present invention further provides a method of making a brown sugar substitute composition. This method includes forming a light formulation by combining from about 0.01 to about 3% by weight of a high intensity sweetener, from about 1 to about 16% by weight of molasses, and from about 1.25 to about 5% by weight of an anti-caking agent. Thereafter, from about 70 to about 99% of a food grade crystalline sugar or sugar alcohol is mixed into the light formulation to form a brown sugar substitute composition.

### BRIEF DESCRIPTION OF THE DRAWINGS

FIG. 1 shows the moisture content of Silver Spoon brown soft sugars, light brown sugar (FIG. 1A) and dark brown sugar (FIG. 1B), stored opened at 0%, 20%, and 33% relative humidity for 2 weeks.

FIG. 2 shows the texture measurements of Silver Spoon brown soft sugars, light brown sugar (FIG. 2A) and dark brown sugar (FIG. 2B), stored opened at 0%, 20%, and 33% relative humidity for 2 weeks.

FIG. 3 shows the texture measurements of brown sugar blend samples with 0.25%, 0.5%, and 1% glycerin, stored in open air for 1 week. The control formulation did not include glycerin.

FIG. 4 shows the effects of 1.25%, 1.5%, and 1.75% glycerin addition to a brown sugar blend on penetration force (FIG. 4A), moisture content (FIG. 4B), and water activity (FIG. 4C) when stored at 20% relative humidity for 8 weeks. The control formulation did not include glycerin.

FIG. 5 shows the effects of 2% and 2.25% glycerin addition to a brown sugar blend on penetration force (FIG. 5A) and moisture content (FIG. 5B) when stored at 0% relative humidity for 2 weeks.

FIG. 6 shows the moisture content values of brown sugar blend samples with 2% glycerin, stored at 20%, 33%, 50%, 65%, and 75% relative humidity for 2 weeks.

FIG. 7 shows the moisture sorption isotherm of a brown sugar blend with 2% glycerin.

### DETAILED DESCRIPTION OF THE INVENTION

The present application is directed to the production of a brown sugar substitute composition by adding a food grade crystalline sugar or sugar alcohol to a molasses-containing light formulation. Unexpectedly and surprisingly, the resulting brown sugar substitute exhibits an improved flavor and a consumer preferred wet texture. In addition, such a composition may be further modified to resist caking by adding at least one anti-caking agent, which provides improved handling characteristics over a range of conditions typically encountered during manufacture, shipping, and storage.

One embodiment of the invention is a brown sugar substitute containing from about 0.01 to about 3% by weight of a high intensity sweetener, from about 1 to about 16% by weight of molasses, from about 70 to about 99% by weight of a food grade crystalline sugar or sugar alcohol, and from about 1.25 to about 5% by weight of at least one anti-caking agent.

In the present invention, the phrases “brown sugar substitute” and “brown sugar substitute composition” are used interchangeably.

As used herein, “crystalline sugar” means any white crystalline carbohydrate that is soluble in water and generally has a sweet taste. Any crystalline sugar known to those skilled in the art can be used in the present invention. The sugar may be a monosaccharide or a disaccharide. Examples of useful monosaccharides include erythrose, threose, arabinose, ribose, ribulose, xylose, xylulose, lyxose, allose, altrose, fructose, galactose, glucose (dextrose), culose, idose, mannose, sorbose, talose, tagatose, and sedoheptulose. Examples of useful disaccharides include sucrose, lactose, maltose, and trehalose. A preferred crystalline sugar is sucrose.

Well-known processes are used to extract and purify sucrose from sugar cane, sugar beets, and other plants. Other sugars, such as, glucose (dextrose) and fructose, can also be produced from various grain plants by well-known processes.

As used herein, “sugar alcohol” means an alcohol derived from a sugar molecule. Sugar alcohols useful in the present invention include, for example, mannitol, sorbitol, lactitol, isomalt, erythritol, xylitol, maltitol, and the like.

As used herein, a “food grade crystalline sugar or sugar alcohol” is a crystalline sugar or sugar alcohol that conforms to the standards for foods deemed safe for human consumption set forth in the Codex Alimentarius produced by the World Health Organization (1999).

As used herein, the term “high intensity sweetener” means a substance that provides a high sweetness per unit mass as compared to a nutritive sweetener and provides little or no nutritive value. Many high intensity sweeteners are known to those skilled in the art and any can be used in the present invention. Examples of high intensity sweeteners for use in the present invention include aspartame, acesulfame K, saccharine, cyclamate, neotame, sucralose, brazien and other protein based sweeteners, such as for example stevia and other plant extracts, and various salts and derivatives thereof. A preferred sweetener according to the present invention is sucralose. High intensity sweeteners are available in various forms, including cubes, tablets, granules, and liquids.

The intensity of a sweetener may be assessed by determining the amount of the sweetener required to provide a sweetness comparable to a predetermined mass of a natural sugar, e.g., sucrose. In the present invention, this parameter is expressed in terms of “sucrose equivalent sweetness”. For example, if a sweetener is twice as intense as sucrose, 0.5 g of the sweetener would equal a gram of sucrose equivalent sweetness.

The brown sugar substitute compositions of the present invention may provide a wide range of sweetness intensities from a fraction of that of sucrose to many times that of sucrose. In one embodiment of the present invention, a teaspoon of the brown sugar substitute delivers from about 1.1 to about 8 sucrose equivalent teaspoons of sweetness. Preferably, a teaspoon of the brown sugar substitute delivers from about 1.5 to about 4, and more preferably, about 2 sucrose equivalent teaspoons of sweetness.

Another component of the brown sugar substitute compositions is molasses. Molasses is a syrup produced during the refining of sugar, having sucrose, invert sugar, ash, water, and other crystallizable and non-crystallizable compounds as its major constituents. There are three major grades of molasses: first molasses, second molasses, and blackstrap molasses. During processing, sugar cane, for example, is harvested and stripped of its leaves. The juice is then extracted from the canes, boiled until it has reached the appropriate consistency, and processed to extract the sugar. The syrup remaining after this first boiling and processing is first molasses, which has the highest sugar content because a relatively high amount of sugar remains in the juice. Second molasses is created from a second boiling and sugar extraction and has a slightly bitter taste. Additional rounds of processing and boiling produce blackstrap molasses. Although not all are equally preferred by bakers and consumers, any grade of molasses can be used in the present invention.

The quality of molasses depends on the maturity of the sugar cane, the amount of sugar extracted, and the method of extraction. There are three major types of molasses: unsulphured, sulphured, and blackstrap.

Unsulphured molasses is the finest quality. It is made from the juice of sun-ripened cane and the juice is clarified and concentrated. Sulphured molasses is made from green (unripe) sugar cane and is treated with sulphur fumes during the sugar extraction process. In the present invention, any type of molasses may be used.

In the present invention, the brown sugar substitute compositions contain from about 1 to about 16% by weight of molasses. Preferably, the brown sugar substitute compositions contain from about 4 to about 16% by weight of molasses. More preferably, the brown sugar compositions contain from about 4 to about 12% by weight of molasses, such as for example from about 5 to about 7% by weight of molasses.

Moisture is an important consideration in a brown sugar product. A range of moisture levels is possible, from about. 0.1%. moisture to about 5% moisture. The most preferred brown sugar products are those where the moisture is provided by the molasses and therefore contains all the molasses flavor notes.

The brown sugar substitutes of the present invention may also include one or more flavors. Any natural or artificial flavor known in the art may be used to highlight the taste of the brown sugar substitute of the invention to account for the natural variation in the molasses used.

The brown sugar substitute compositions of the present invention also include an anti-caking agent. The anti-caking agent of the present invention acts as a solvent for the molasses and also exhibits hydrophilic properties. Moreover, the anti-caking agent slows crystal formation as the molasses dries. Not wishing to be bound by a particular theory, it is believed that in the brown sugar substitute compositions of the present invention, the anti-caking agent acts to resist the rapid crystallization resulting in bridging between the brown sugar substitute granules, which leads to caking. Accordingly, any food grade agent that promotes the resistance of rapid crystallization between the brown sugar substitute granules may be used as an anti-caking agent in any of the embodiments of the present invention. Preferably, however, the anti-caking agent is glycerin, propylene glycol, or mixtures thereof.

The anti-caking agent may be present in any amount sufficient to prevent caking of the brown sugar substitute at a low relative humidity, e.g. 20%. The anti-caking agent, however, may not be present in amounts great enough to cause the agent to slide off of the brown sugar substitute granules. Thus, as noted above, the brown sugar substitute compositions of the present invention contain from about 1.25 to about 5% by weight of an anti-caking agent. Preferably, the brown sugar substitute compositions contain from about 1.25 to about 3% by weight of the anti-caking agent. More preferably, the brown sugar substitute compositions include about 1.25 to about 2.5%, such as about 2%, by weight of the anti-caking agent.

Generally, the amount of anti-caking agent required will be directly proportional to the amount of molasses in the brown sugar substitute. Thus, as the amount of molasses in the brown sugar substitute increases, the amount of anti-caking agent required to resist caking and maintain the wet feel of the brown sugar substitute will increase. Thus, the ratio of anti-caking agent to molasses may be from about 1:6 to about 2:6.

With the use of one or more anti-caking agents, the brown sugar substitute compositions are more resistant to crystal formation and are less prone to forming hard, undesirable cakes or blocks. One measure of this undesirable “caking” characteristic, “penetration force”, evaluates how strongly bound together the particles of a granular substance are. In the context of the present invention, the penetration force of a brown sugar substitute is the force required for a P/40C 40° Perspex conical probe to advance 1 cm in a sample of the brown sugar substitute. As used herein, a brown sugar substitute composition having a penetration force of 20 N is roughly equivalent to a composition that a consumer would consider unusable because it cannot be packed into a measuring device, e.g., a measuring cup, without extraordinary effort. Thus, a brown sugar substitute that has a penetration force greater than 20 N is generally not desirable to a consumer. Accordingly, in one embodiment of the present invention, the penetration force of the brown sugar substitute of the present invention is less than about 20 N.

The present invention may be delivered in any packaged form typically used for delivering brown sugar. Generally, the brown sugar substitute can be packaged for industrial or commercial use, such as in the food services industry, or for use by consumers in the same manner as brown sugar. These packaged forms may include, for example, boxes, bags, drums, tubs, and the like, and individual use (i.e., unit package) forms, such as packets.

Moreover, the brown sugar substitute of the present invention may be incorporated into premixed food or beverage preparations in the same manner as brown sugar. Food preparations may include, for example, cookie or cake mix and cookie dough. Preparations of this type will provide the same convenience as those containing brown sugar, but have the advantage of delivering fewer calories.

Another embodiment of the present invention is a brown sugar substitute containing from about 80 to about 95% by weight of a food grade crystalline sugar or sugar alcohol, from about 4 to about 16% by weight of molasses, from about 1.25 to about 3% by weight of at least one anti-caking agent, and from about 0.01 to about 3% by weight of a high intensity sweetener, wherein less than about 3.5 kcals per gram of sucrose equivalent sweetness are delivered. In this embodiment, the crystalline sugar or sugar alcohol, molasses, anti-caking agent, and high intensity sweeteners may be used in the manner and amounts previously described.

A further embodiment of the present invention is a method of making a brown sugar substitute containing an anti-caking agent. This method includes forming a light formulation by combining from about 0.01 to about 3% by weight of a high intensity sweetener, from about 1 to about 16% by weight of molasses, and from about 1.25 to about 5% by weight of at least one anti-caking agent. Thereafter, from about 70 to about 99% of a food grade crystalline sugar or sugar alcohol is combined, e.g., by mixing, spraying and the like, into the light formulation to form a brown sugar substitute.

In the present invention, any conventional combining step may be used. For example, to form the light formulation, the molasses is heated and combined with the high intensity sweetener and, optionally, any desired flavor, to form a slurry. The components of the light formulation may be combined by any means known in the art to form a slurry. Preferably, the components are blended. The molasses is heated to about 90° F. to about 150° F., preferably to about 90° F. to about 140° F., most preferably to about 120° F.

The food grade crystalline sugar or sugar alcohol is then coated with the slurry. The coating may be accomplished by any means known in the art. Preferably, the slurry is poured or sprayed onto the food grade crystalline sugar while mixing or the slurry is blended with the food grade crystalline sugar.

The amount and identity of the high intensity sweetener, molasses, anti-caking agent, and food grade crystalline sugar or sugar alcohol used in this method are as described above.

The following examples are provided to further illustrate the compositions and methods of the present invention. These examples are illustrative only and are not intended to limit the scope of the invention in any way.

### EXAMPLES

### Brown Sugar Substitute

### Example 1

Three 100 lb. batches of a brown sugar substitute are made by combining 0.88 lbs of a flavor/sucralose/water pre-blend which contains about 0.0852 lb Robertet NV-12,294 (Robertet Flavors, Piscataway, N.J.), about 0.0284 lb Robertet NV-23,601, about 0.25 lb sucralose, and about 0.6364 lb water, about 7.00 lbs. of molasses (Paulaur Corp., Cranbury, N.J.—lot # 800002), and about 92.12 lbs of sucrose (Extra Fine, Fruit, or Bakers Special granulation) (Domino Sugar, Baltimore, Md.). The molasses is pre-heated to about 140° F. and blended with the pre-blend to form a slurry. The resulting slurry is poured directly onto the sucrose (while mixing) over a period of approximately one minute. The mixer is an 8-cu/ft pilot plant ribbon blender operated at about 91 rpm.

The mixer is stopped about 4 to about 5 minutes after the slurry is added to the sucrose. Thereafter, approximately half of the product is removed and packed in 50 lb. boxes with two 2 mil polyethylene liners.

The remaining product is blended for approximately 5 to 6 additional minutes then removed from the mixer and packed in 50 lb. boxes with two 2 mil polyethylene liners.

### Example 2

A 100 lb. batch of a brown sugar substitute is made with about 0.88 lbs. of a flavor/sucralose/water pre-blend which contains about 0.0852 lb Robertet NV-12,294, about 0.0284 lb Robertet NV-23,601, about 0.25 lb sucralose, and about 0.6364 lb water, about 7.00 lbs. of molasses (Paulaur lot # 800002), and about 92.12 lbs of sucrose (Domino Fine Sugar). The molasses is pre-heated to about 140° F. and blended with the pre-blend to form a slurry. The slurry is sprayed (at 85 psi using two QPT-6550 wide spray tips) onto the sucrose (while mixing) over approximately two minutes. The mixer is an 8-cu/ft pilot plant ribbon blender operated at 91 rpm.

The mixer is stopped about 4 to about 5 minutes after the slurry is added to the sucrose. Samples are obtained from 4 points. Thereafter, approximately half of the product is removed and packed in 50 lb. boxes with two 2 mil polyethylene liners.

The remaining product is blended for approximately 5 to 6 additional minutes then removed from the mixer and packed in 50 lb. boxes with two 2 mil polyethylene liners.

### Example 3

About twenty-four hours prior to use, a slurry is produced by mixing about 2.86 lbs. of neat sucralose (Tate & Lyle, Decatur, Ill.) into about 91 lbs. of molasses (Paulaur lot # 800002) and heated to about 140° F. Immediately before use, two flavors (0.975 lbs. of Robertet NV-12,294 & 0.325 lbs. of NV-23,601) are blended into the slurry using a high shear mixer (ARDE-BARINCO, #1006, Norwood, N.J.) (65 rpm) for one minute. The slurry is maintained at about 140° F. until use.

A 1300 lb. batch of a brown sugar substitute is made with about 95 lbs. of the above slurry and about 1205 lbs. of extra fine sucrose (Domino Sugar). The slurry is added directly to the sugar in a blender over the course of 6 minutes while the blender is operating. The blender is a 100-gallon horizontal cylindrical blender operating at 25 rpm (McCarter, Norristown, Pa.). Immediately following slurry addition, a portion of the blend material (about 25 lbs.) is removed from the blender outlet and recycled back into the batch.

After about 40 minutes of mixing, the product is packed into drums with two 2 mil polyethylene liners (about 300 lbs/drum).

### Example 4

About twenty-four hours prior to use, a slurry is produced by mixing about 5.95 lbs. of neat sucralose (Tate & Lyle) into about 189 lbs. of molasses (Paulaur lot # 800002) and heated to about 140° F. Immediately before use, two flavors (about 2.025 lbs. of Robertet NV-1 2,294 & about 0.675 lbs. of NV-23,601) are blended into the slurry with a small propeller mixer 71636819 type 63 (Neptune Mixer Co., Lansdale, Pa.) set at 60 rpm for about one minute. The slurry is maintained at about 140° F. until use.

A 2700 lb. batch of a brown sugar substitute is made with about 198 lbs. of the above slurry and about 2502 lbs. of extra fine sucrose (Domino Sugar). The slurry is added directly to the sugar in a blender over the course of 6 minutes while the blender is operating. The blender is a 120-cu/ft-paddle blender operated at about 25 rpm. Immediately following slurry addition, a portion of the blend material (about 150 lbs.) is removed from the blender outlet and recycled back into the batch.

After about 10 minutes of mixing, one drum (about 300 lbs.) is immediately removed from the batch.

After a total mix time of about 26 minutes, the remaining product is packed into a 42-cu/ft-polyethylene bin and drums with two 2 mil polyethylene liners. The blender discharge takes about 12 minutes.

### Brown Sugar Substitute With Anti-Caking Agent

### Example 5

Brown sugar blends are produced as shown in Table 1. Domino ExtraFine Sugar (Domino Sugar) is used in all formulations except Formula 1, where it is replaced by Domino Baker's Special Sugar (Domino Sugar). Other ingredients are Blackstrap Molasses Lot # 800002 (Paulaur), Glycerin USP 99.7% Kosher Lot # 19188B (Acme-Hardesty Co., Blue Bell, Pa.), and Krystar 300 Crystalline Fructose (Tate & Lyle). The formulations in Table 1 do not include sucralose or flavors because they are used in the brown sugar substitute at very low levels and do not affect caking during storage.

TABLE 1
Brown sugar blend formulations.

Ingredients (%)

| Formula | Sugar | Molasses | Glycerin | Fructose |
|---|---|---|---|---|
| 1 | 95.9 | 4.1 | | |
| 2 | 93 | 7 | | |
| 3 | 91.25 | 7 | | 1.75 |
| 4 | 89.5 | 7 | | 3.5 |
| 5 | 87.75 | 7 | | 5.25 |
| 6 | 92.75 | 7 | 0.25 | |
| 7 | 92.5 | 7 | 0.5 | |
| 8 | 92 | 7 | 1 | |
| 9 | 91.75 | 7 | 1.25 | |
| 10 | 91.5 | 7 | 1.5 | |
| 11 | 91.25 | 7 | 1.75 | |
| 12 | 91 | 7 | 2 | |
| 13 | 90.75 | 7 | 2.25 | |

The samples are placed in 1 oz. plastic cups, with very limited tapping. The cups are stored at room temperature and various relative humidity levels, as described below. To create the relative humidity levels, saturated salt solutions are placed in large surface trays inside small environmental chambers. The salts used for each chamber (chosen for 25° C., according to Labuza, T. “Creation of Moisture Sorbtion Isotherms for Hygroscopic Materials”. Available online at: http://faculty.che.umn.edu/fscn/Ted_Labuza/PDF_files/Papers/Creation_Moistu re_Isoterms.PDF) are listed in Table 2.

TABLE 2
Salts used to control relative humidity.

| | Relative | |
|---|---|---|
| | Humidity | |
| Chamber # | (%) | Salt used |
| 1 | 0 | Drierite (Drierite Co. Xenia, Ohio) |
| 2 | 20 | Potassium Acetate (Mallinckrodt Baker |
| | | Inc., Paris, Kentucky |
| 3 | 33 | Magnesium Chloride (Fisher Scientific, |
| | | Fairlawn, New Jersey) |
| 4 | 50 | Magnesium Nitrate (Fisher Scientific) |
| 5 | 65 | Cobalt Chloride (Mallinckrodt Baker) |
| 6 | 75 | Sodium Chloride (Fisher Scientific) |

The samples are analyzed for moisture content using a CompuTrac Moisture Analyzer (Arizona Instruments LLC, Tempe, Ariz.). Water activity is measured using a HygroLab 3 Water Activity Station (Rotronic Instument Corp., Huntington, N.Y.). Cake hardness is evaluated using a TA.XT2 Texture Analyzer (Texture Technologies Corp., Scarsdale, N.Y.) by measuring the penetration force required for a P/40C 40° Perspex conical probe to advance 1 cm in the sample. A sample is considered to have failed on force is 20 N or greater.

### I. Relative Humidity Range Causing Failure

To identify the relative humidity range where the brown sugar blend without humectants cakes, samples of Formula 2 are stored under open air conditions (25° and 18-23% relative humidity) until they become rock hard. The samples are then stored at 20%, 33%, 50%, and 65% relative humidity for 3 days. Samples stored at 20% and 33% relative humidity remain hard. Samples stored at 50% and 65% relative humidity become soft after 2 days. Thus, the point of failure is between 33% and 50% relative humidity. This experiment verifies that it is possible to regenerate the caked brown sugar blend by storing it in a high relative humidity environment.

To narrow the relative humidity range, portions of the same sample are stored for 1 week at 33% and 50% relative humidity. Blends of these portions in 2:1, 1:1, and 1:2 ratios (w/w) are then placed in pouches, quickly mixed, and sealed. After one week the pouches are opened and the samples are evaluated for moisture content and water activity, and are visually evaluated for caking. The results, shown in Table 3, indicate that the relative humidity that causes brown sugar failure is about 45%.

TABLE 3
Evaluation of the brown sugar blends at various water activities.

| | 33% | 50% | | | |
|---|---|---|---|---|---|
| | Relative | Relative | Moisture | | |
| | Humidity | Humidity | Content | Water | |
| Ratio | (g) | (g) | (%) | Activity | Texture |
| 2:1 | 60 | 30 | 0.40 | 0.39 | Failed |
| 1:1 | 45 | 45 | 0.46 | 0.43 | Failed |
| 1:2 | 30 | 60 | 0.56 | 0.45 | Acceptable |

### II. Analysis of the Silver Spoon Brown Soft Sugars

The glycerin content of Silver Spoon Light Brown Soft (“LBS”) Sugar (lot # 3045L4Y) and Dark Brown Soft (“DBS”) Sugar (lot # 5424L4Y) (both Silver Spoon Co., Peterborough, England) is 0.83% and 1.11%, respectively. This analysis is performed by Covance Inc. (Princeton, N.J.).

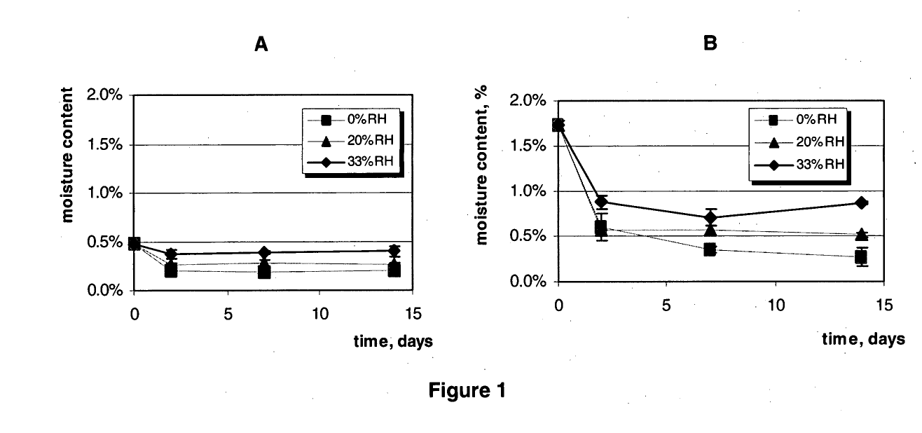

Samples of each sugar are placed in 1 oz. plastic cups and stored for 2 weeks at 0%, 20%, and 33% relative humidity. For LBS, the moisture content for each sample is constant after 2 days (FIG. 1A), suggesting that LBS reaches equilibrium. For DBS, equilibrium is reached in 2-7 days at 20 and 33% relative humidity, but not at 0% relative humidity (FIG. 1B). This may be an effect of the larger amount of molasses in the DBS, which delays the moisture loss compared to LBS.

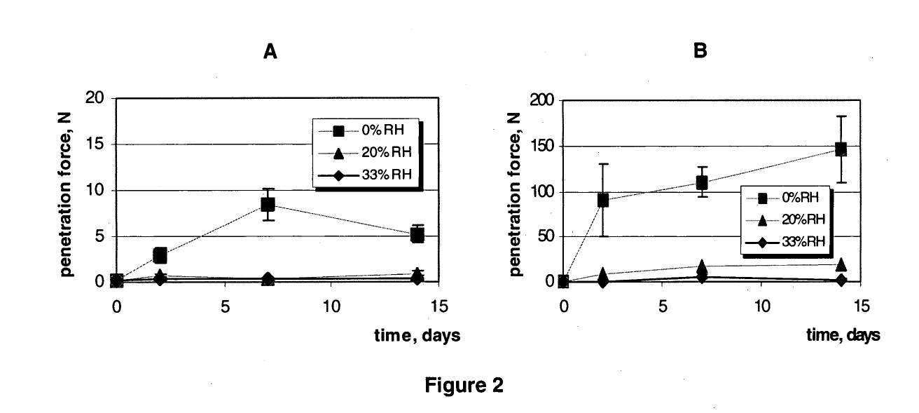

Only very small changes in the penetration force are found at 20% and 33% relative humidity for both sugars (FIGS. 2A and B). At 0% relative humidity, both brown sugars show a statistically significant increase in the penetration force relative to the other conditions. However, at 0% relative humidity the DBS fails in less than 2 days, while LBS does not fail in 2 weeks.

### III: Levels of Humectants to Prevent Caking of Brown Sugar Blends

Samples of brown sugar blends are prepared with 0.25%, 0.5%, and 1% glycerin by weight of the total formula (Formulas 6, 7 and 8, respectively). The samples are stored in open air for 1 week (20-22° C., 15-22& relative humidity except day 3 when the relative humidity is 46%). The results on day 3 confirm the previous finding that a brown sugar blend can be softened by picking up moisture from a high relative humidity environment.

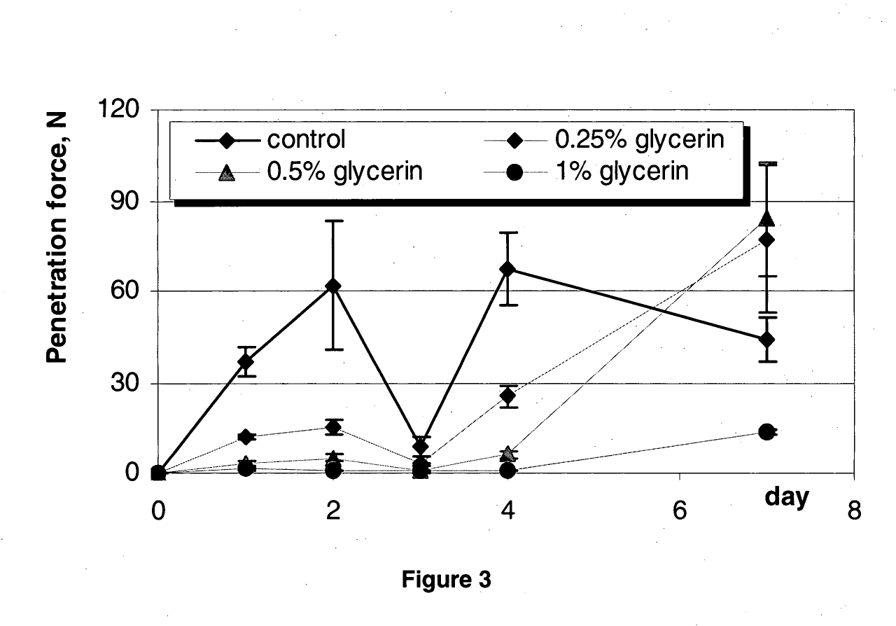

The addition of glycerin significantly reduces the caking behavior of the brown sugar blend (FIG. 3). The control (no glycerin) fails in less than 1 day. The 0.25% glycerin sample fails on day 4. The 0.5% glycerin sample fails on day 5. The 1% glycerin sample does not fail over the week storage, although a gradual increase in the penetration force is observed.

Samples of brown sugar blends are prepared with 1.25%, 1.5%, and 1.75% glycerin (Formulas 9, 10, and 11, respectively) and stored at 20% relative humidity for 8 weeks. In addition, samples of brown sugar blends are prepared with 1.75%, 3.5%, and 5.25% fructose (Formulas 3, 4, and 5, respectively). Moisture content, water activity, texture, and sample color are evaluated. Sample color is determined using a ColorQuest XE Colorimeter (HunterLab Associates Inc., Reston, Va.). The analysis of a sample is discontinued once it fails, i.e., when the penetration force exceeds 20N.

The fructose samples fail on week 1 demonstrating that fructose is not efficient in preventing brown sugar blend caking (Table 4).

TABLE 4
Penetration force (N) of brown sugar blends
with 1.75%, 3.5% and 5.25% fructose.

| | Formula # | | | | |
|---|---|---|---|---|---|
| | 1 | 2 | 3 | 4 | 5 |
| Fructose, % | 0 | 0 | 1.75 | 3.5 | 5.25 |
| Week | | | | | |
| 0 | 21.95 | 6.89 | 6.89 | 5.41 | 13.04 |
| 1 | 79.37 | 158.53 | 128.42 | 163.9 | 136.04 |
| Comments | 4% molasses, | control | | | |
| | Bakers' Special | | | | |

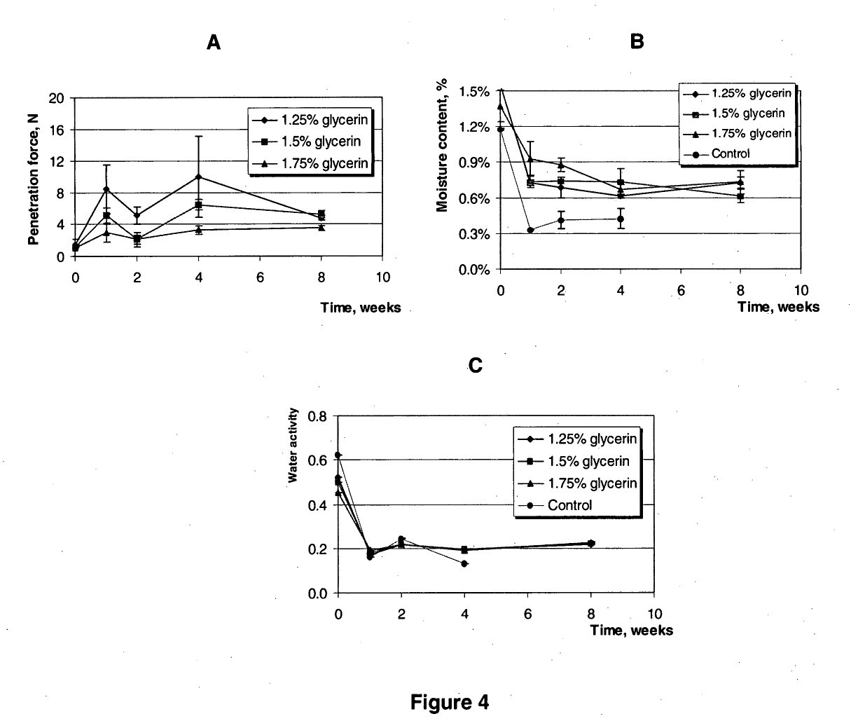

The samples with glycerin do not fail over 8 weeks and appear to equilibrate after about 2 weeks of storage (FIGS. 4A, B, and C). The samples containing glycerin have 50% higher equilibrium moisture content than the control without glycerin. As seen in Table 5, the samples with glycerin are also slightly lighter (higher L) and less yellow (lower b), but the differences are not detected visually.

TABLE 5
Color measurements of brown sugar blend with 1.25%, 1.5%, and
1.75% glycerin stored at 20% relative humidity for 8 weeks.

| | Sample | | | | | | | | | | | |
|---|---|---|---|---|---|---|---|---|---|---|---|---|
| | Control | | | Formula 9 | | | Formula 10 | | | Formula 11 | | |
| | Glycerin (%) | | | | | | | | | | | |
| | 0 | | | 1.25 | | | 1.5 | | | 1.75 | | |
| Week | L | a | b | L | a | b | L | a | b | L | a | b |
| 0 | 40.26 | 7.57 | 16.74 | 42.44 | 7.66 | 17.1 | 40.83 | 7.83 | 16.46 | 40.3 | 7.86 | 16.61 |
| 1 | 39.95 | 7.66 | 16.58 | 40.27 | 7.57 | 16.11 | 39.8 | 7.61 | 15.82 | 39.49 | 7.72 | 15.8 |
| 2 | 40.2 | 7.68 | 16.7 | 40.35 | 7.5 | 15.72 | 38.58 | 7.74 | 15.5 | 39.22 | 7.81 | 15.52 |
| 4 | 39.2 | 7.62 | 16.29 | 40.06 | 7.45 | 15.36 | 38.15 | 7.64 | 15.08 | 38.75 | 7.74 | 15.39 |
| 8 | | | | 39.65 | 7.48 | 15.16 | 37.89 | 7.62 | 14.75 | 39.58 | 7.59 | 15.02 |

Thus, glycerin levels above 1.25% are effective in preventing caking at 20% relative humidity.

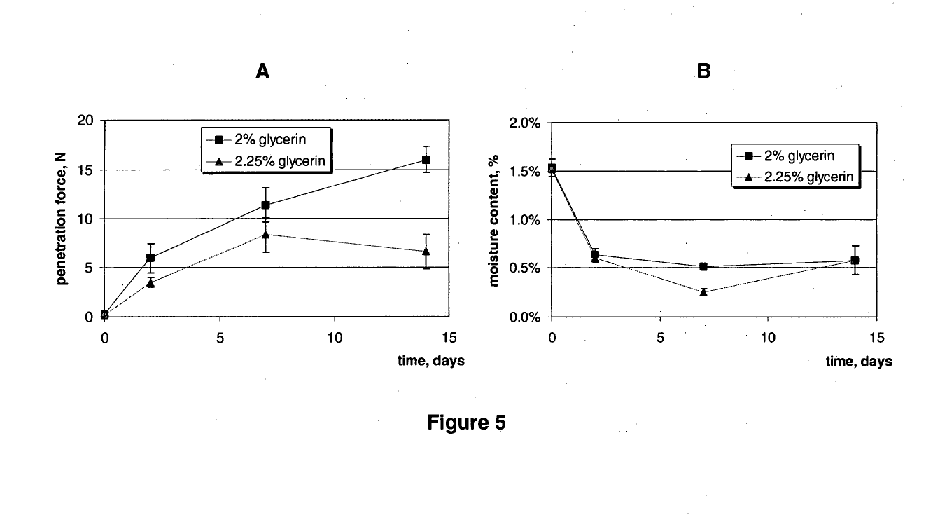

Samples are then prepared with 2% and 2.25% glycerin and stored for 2 weeks at 0% relative humidity. These samples do not fail and have an equilibrium moisture content of about 0.5% (FIGS. 5A and B). It is unlikely that 0% relative humidity will exist for extended durations in any consumer storage environment, therefore, it can be concluded that a brown sugar blend. with 2% glycerin or more would never cake under normal conditions.

### IV. Storage of Brown Sugar Blend with 2% Glycerin at Selected Relative Humidity Levels

Since 2% glycerin is shown to prevent caking in a brown sugar blend, moisture content and water activity are measured on samples stored at room temperature and 20%, 33%, 50%, 65%, and 75% relative humidity. The measurements are performed after 2 days, 1 week, and 2 weeks (based on the findings above, samples reach equilibrium after 2 weeks).

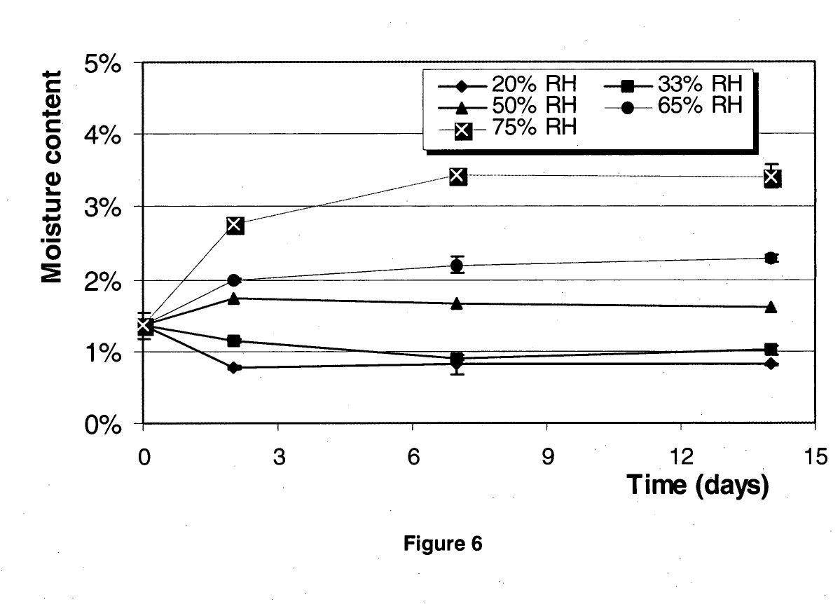

The moisture content measurements show that equilibrium is reached after 1 week (FIG. 6). The equilibrium moisture content is strongly affected by the relative humidity.

None of the samples fails at these relative humidity levels, with the highest penetration force being approximately 0.9N after 2 weeks at 20% relative humidity. This confirms that brown sugar blends with 2% glycerin will remain soft over the shelf life of the product.

The water activity levels of the samples after 1 week and 2 weeks of storage confirm that equilibrium is reached after 1 week (Table 6). At 75% relative humidity the water activity is above the 0.65 limit for growth of osmophilic yeasts and molds (Fennema, O.R. (1996) “Water and Ice”, in: Fennema, O.R. (ed.) Food Chemistry. Marcel Dekker, New York., pp. 17-94), so microbial spoilage may limit the shelf life in these conditions.

TABLE 6
Water activity of brown sugar blend samples
with 2% glycerin, stored at 20%, 33%, 50%, 65%,
and 75% relative humidity for 2 weeks.

| | Relative Humidity (%) | | | | |
|---|---|---|---|---|---|
| Day | 20 | 33 | 50 | 65 | 75 |
| 7 | 0.24 | 0.31 | 0.54 | 0.60 | 0.69 |
| 14 | 0.26 | 0.33 | 0.53 | 0.63 | 0.72 |

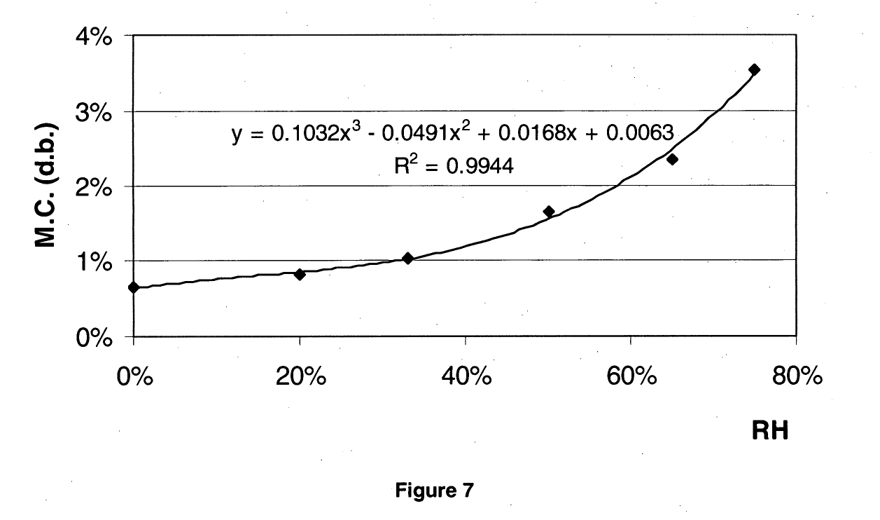

The moisture sorption isotherm in FIG. 7 is obtained using the data above. Curve fitting using a 3^{rd} order polynomial shows a very good fit. This equation may be used to predict the moisture intake of the brown sugar substitute with 2% glycerin.

### Example 6

### Liquid Premix

A liquid premix is produced as shown in Table 7. The glycerin (KIC Chemicals, Inc., Armonk, N.Y.) is placed in the mixer bowl of a 200 gallon mixer having a vertical propeller shaft and two vertical baffles. The mixer is started and run at a speed of about 600 rpm. Micronized sucralose (Tate & Lyle) is added to the mixing bowl. Visual uniformity is achieved in less than 2 minutes of mixing. The molasses is pre-heated at 119° F. (48° C.). The molasses (Paulaur 1271 lbs of lot # 014294 and 123.7 lbs of lot # 105038) and the flavor component (Robertet NV-34,554) are then added to the mixing bowl, with continued mixing. The liquid premix is produced in a room at about 63° F. (17° C.) and 65% relative humidity.

TABLE 7
Liquid premix formulation.

| Ingredient | | Lbs | Kg | % |
|---|---|---|---|---|
| Liquid Premix | Glycerin | 399.8 | 181.4 | 21.5 |
| | Micronized Sucralose | 43.9 | 19.9 | 2.36 |
| | Flavor | 21.4 | 9.7 | 1.15 |
| | Molasses | 1394.7 | 632.6 | 75.0 |

| | | | |
|---|---|---|---|
| TOTAL | 1859.9 | 843.6 | 100 |

The time from starting the mixer to the addition of the final ingredient is 1 hour, at which point the temperature in the bowl is 108° F. (42° C.). Mixing is continued for an additional 20 minutes at 700 rpm. After blending uniformity is reached, the liquid premix is pumped in three 55 gallon drums, having net weights of 595, 619, and 623 lbs, respectively. The process yield is 98.77% (1.23% losses).

The average sucralose content for the samples collected from drums 1-3 is 2.30% (See Table 8). The sucralose content of the sample collected after blending the full batch for 5 minutes is within one SD from the average value for the drums premix, which confirms that blending for 5 minutes is sufficient to uniformly distribute sucralose within the liquid premix.

TABLE 8
Liquid premix sucralose content (%).

| | | 1^{st} | 2^{nd} | |
|---|---|---|---|---|
| Sample | Amount (g) | reading | reading | Average |
| Prepackaging | 3.733 | 2.33 | 2.34 | 2.33 |
| sample | | | | |
| Drum #1 | 3.736 | 2.28 | 2.27 | 2.28 |
| Drum #2 | 3.732 | 2.27 | 2.38 | 2.32 |
| Drum #3 | 3.731 | 2.31 | 2.28 | 2.29 |

| | |
|---|---|
| Overall Average | 2.30 |
| Std. dev. | 0.044 |
| CV | 1.91% |

As seen in Table 9, the average O.D._{420 nm} of the samples collected from drums 1-3 is 0.57. The absorbance color reading for the sample collected after blending for 5 minutes is within one SD from the average value for the drums premix, which confirms that blending for 5 minutes is enough to ensure an adequate uniformity of the liquid premix.

TABLE 9
Absorbtion color (O.D._{420 nm}).

| Sample | Amount (g) | 1^{st} reading | 2^{nd} reading | Average |
|---|---|---|---|---|
| Molasses | 0.5013 | 0.749 | 0.749 | 0.747 |
| (Lot # 014294) | | | | |
| Molasses | 0.5014 | 0.714 | 0.716 | 0.714 |
| (Lot # 015038) | | | | |
| Prepackaging sample | 0.5 | 0.565 | 0.565 | 0.565 |
| Drum #1 | 0.5004 | 0.565 | 0.575 | 0.570 |
| Drum #2 | 0.501 | 0.573 | 0.572 | 0.571 |
| Drum #3 | 0.5014 | 0.568 | 0.573 | 0.569 |

| | |
|---|---|
| Overall Average | 0.57 |
| Std. dev. | 0.004 |
| CV | 0.65% |

Note:
the average is corrected for variations in amount.

### Sucralose Brown Sugar Blend

A 3308 lb batch of a sucralose brown sugar blend is produced as shown in Table 10. The Domino EFG Sugar is added to the blender (American Process Systems (Gurnee, Ill.) Ribbon Blender DRB200 (200 ft³, double spiral ribbons, 20 hp motor, 20 rpm empty)) while running. The liquid premix is slowly poured through the top blender grate over a five-minute interval. Once addition of the liquid premix is completed, material in the outlet valve is recycled back through the top of the mixer. Visual uniformity is achieved in less than 2 minutes of mixing.

The sucralose brown sugar blend is mixed for three minutes after the completion of liquid premix addition. A color check is then performed using a Pantone® Color Cue. All five Pantone® Color Cue L values for the sucralose brown sugar blend read 44.72. The duration between starting the sugar addition and finishing the liquid premix addition is 10 minutes. The sucralose brown sugar blend is produced in a room at about 63° F. (17° C.) and 67% relative humidity.

TABLE 10
Sucralose brown sugar blend formulation.

| | Ingredient | lbs | kg | % |
|---|---|---|---|---|
| Sucralose Brown | Liquid Premix | 308.0 | 139.7 | 9.32 |
| Sugar Blend | Domino EFG Sugar | 3000.0 | 1360.8 | 90.68 |
| Formula | Total | 3308.0 | 1500.5 | 100 |

The product is discharged into 150 lbs. boxes with two 2 mil polyethylene liners (21 boxes). The net weight for all the boxes is 3157.3 lbs. The process yield is 95.4% (4.6% losses). The product discharge takes 50 minutes.

Samples of about 200 g are collected from every other box (1, 3, 5, 7, 9, 11, 13, 15, 17, 19, and 21). Each sample is split with one set sent to IFN (International Food Network, Inc., Ithaca, N.Y.) and the other kept at Paulaur for sucralose analysis by HPLC. Blend uniformity is determined from the sucralose content of the samples. Approximately 400 g of product is collected, in duplicate, from box #11 for physical testing. Testing is conducted using the art recognized methods identified in Table 11.

TABLE 11
Testing methods.

| Parameter | Method | Replicates |
|---|---|---|
| Sucralose Content | TM-1074 (20.0 g sample in | 2 |
| | 100 ml mobile phase) | |
| Reflectance Color | Hunter Colorquest XE | 2 |
| Moisture Content | Computrac Max 1000 | 2 |
| Water Activity | Rotronic HygroLab | 2 |
| Loose Bulk Density | TM-1219 | 3 |
| Packed Density | IFN-67 | 3 |

The average sucralose content for the samples collected from boxes one through twenty-one is 0.21% (See Table 12). The relative standard deviation is 2.59%. This confirms that blending is sufficient to uniformly distribute liquid premix throughout the final product within 5 minutes of addition (including recycle and color check time).

TABLE 12
Sucrose content (IFN results).

| | | 1^{st} | 2^{nd} | |
|---|---|---|---|---|
| | | reading | reading | |
| Sample | Amount (g) | (%) | (%) | Average (%) |
| Box # 1 | 20.0038 | 0.19 | 0.19 | 0.19 |
| Box # 3 | 20.0006 | 0.20 | 0.20 | 0.20 |
| Box # 5 | 20.0064 | 0.21 | 0.21 | 0.21 |
| Box # 7 | 20.0095 | 0.21 | 0.21 | 0.21 |
| Box # 9 | 20.0065 | 0.20 | 0.20 | 0.20 |
| Box # 11 | 20.0029 | 0.21 | 0.21 | 0.21 |
| Box # 13 | 20.0009 | 0.21 | 0.21 | 0.21 |
| Box # 15 | 20.0035 | 0.21 | 0.21 | 0.21 |
| Box # 17 | 20.0049 | 0.21 | 0.21 | 0.21 |
| Box # 19 | 20.0036 | 0.21 | 0.21 | 0.21 |
| Box # 21 | 20.0048 | 0.20 | 0.20 | 0.20 |

| | |
|---|---|
| Overall Average | 0.21 |
| Std. dev. | 0.005 |
| RSD | 2.59% |

The result for each of the physical parameter tests is reported in Table 13.

TABLE 13
Physical test data.

| | | Loose Bulk | Packed | Hunter Color |
|---|---|---|---|---|
| Moisture | Water Activity | Density | Density | L Value |
| 1.99% | 0.577 @ 22° C. | 0.68 g/cc | 0.92 g/cc | 41.93 |

The scope of the present invention is not limited by the description, examples and suggested uses herein and modifications can be made without departing from the spirit of the invention. Thus, it is intended that the present invention cover modifications and variations of this invention provided that they come within the scope of the appended claims and their equivalents.

What is claimed is:

1. A brown sugar substitute comprising:
from about 0.01 to about 3 wt % high intensity sweetener;
from about 1 to about 16 wt % molasses;
from about 70 to about 99 wt % of a food grade crystalline sugar or sugar alcohol; and
from about 1.25 to about 5 wt % of at least one anti-caking agent.

2. A brown sugar substitute according to claim 1, wherein the high intensity sweetener is selected from the group consisting of aspartame, acesulfame K, saccharine, cyclamate, neotame, sucralose, brazien, stevia, various salts thereof, and mixtures thereof.

3. A brown sugar substitute according to claim 2, wherein the high intensity sweetener is sucralose.

4. A brown sugar substitute according to claim 1, comprising from about 4 to about 12 wt % of molasses.

5. A brown sugar substitute according to claim 1, comprising from about 5 to about 7 wt % molasses.

6. A brown sugar substitute according to claim 1, wherein the food grade crystalline sugar is sucrose.

7. A brown sugar substitute according to claim 1, wherein a teaspoon of the brown sugar substitute provides between about 1.1 and about 8 sucrose equivalent teaspoons of sweetness.

8. A brown sugar substitute according to claim 7, wherein a teaspoon of the brown sugar substitute provides between about 1.5 and about 4 sucrose equivalent teaspoons of sweetness.

9. A brown sugar substitute according to claim 8, wherein a teaspoon of the brown sugar substitute provides about 2 sucrose equivalent teaspoons of sweetness.

10. A brown sugar substitute according to claim 1, comprising from about 1.25 to about 3 wt % of an anti-caking agent.

11. A brown sugar substitute according to claim 1, comprising from about 1.25 to about 2.5 wt % of an anti-caking agent.

12. A brown sugar substitute according to claim 1, comprising about 2 wt % of an anti-caking agent.

13. A brown sugar substitute according to claim 1, wherein the anti-caking agent is selected from the group consisting of glycerin, propylene glycol, and mixtures thereof.

14. A brown sugar substitute according to claim 1, wherein the ratio of the anti-caking agent to molasses is from about 1:6 to about 2:6.

15. A brown sugar substitute according to claim 1, wherein the brown sugar substitute has a penetration force of less than about 20 N.

16. A brown sugar substitute according to claim 1, further comprising a flavor.

17. A brown sugar substitute according to claim 1 dispersed within a packaged form.

18. A brown sugar substitute according to claim 17, wherein the packaged form is selected from the group consisting of boxes, bags, drums, tubs, and individual use packets.

19. A brown sugar substitute comprising:
from about 80 to about 95 wt % of a food grade crystalline sugar or sugar alcohol;
from about 4 to about 16 wt % molasses;
from about 1.25 to about 3 wt % of at least one anti-caking agent; and
from about 0.01 to about 3 wt % of a high intensity sweetener,
wherein less than about 3.5 kcals per gram of sucrose equivalent sweetness are delivered.

20. A brown sugar substitute according to claim 19, wherein the high intensity sweetener is selected from the group consisting of aspartame, acesulfame K, saccharine, cyclamate, neotame, sucralose, brazien, stevia, various salts thereof, and mixtures thereof.

21. A brown sugar substitute according to claim 20, wherein the high intensity sweetener is sucralose.

22. A brown sugar substitute according to claim 19, wherein the food grade crystalline sugar is sucrose.

23. A brown sugar substitute according to claim 19, comprising from about 1.25 to about 2.5 wt % of an anti-caking agent.

24. A brown sugar substitute according to claim 19, comprising about 2 wt % of an anti-caking agent.

25. A brown sugar substitute according to claim 19, wherein the anti-caking agent is selected from the group consisting of glycerin, propylene glycol, and mixtures thereof.

26. A method of making a brown sugar substitute comprising:
forming a light formulation by combining:
from about 0.01 to about 3 wt % high intensity sweetener;
from about 1 to about 16 wt % molasses; and
from about 1.25 to about 5 wt % of at least one anti-caking agent, and
mixing from about 70 to about 99 wt % of a food grade crystalline sugar or sugar alcohol into the light formulation to form a brown sugar substitute.

27. A method according to claim 26, wherein the high intensity sweetener is selected from the group consisting of aspartame, acesulfame K, saccharine, cyclamate, neotame, sucralose, brazien, stevia, various salts thereof, and mixtures thereof.

28. A method according to claim 27, wherein the high intensity sweetener is sucralose.

29. A method according to claim 26, wherein the food grade crystalline sugar is sucrose.

30. A method according to claim 26, comprising from about 1.25 to about 3 wt % of an anti-caking agent.

31. A method according to claim 26, comprising from about 1.25 to about 2.5 wt % of an anti-caking agent.

32. A method according to claim 26, comprising about 2 wt % of an anti-caking agent.

33. A method according to claim 26, wherein the anti-caking agent is selected from the group consisting of glycerin, propylene glycol, and mixtures thereof.

34. A method according to claim 26 further comprising adding a flavor to the light formulation prior to the mixing step.
